(19) United States
(12) Patent Application Publication
(10) Pub. No.: US 2012/0038494 A1
(43) Pub. Date: Feb. 16, 2012

(54) Man overboard self rescue device

(76) Inventors: James B. Read, Inverness, CA (US); Abbie Ann Read, Inverness, CA (US)

(21) Appl. No.: 12/806,553

(22) Filed: Aug. 14, 2010

(51) Int. Cl. G08B 23/00

(52) U.S. Cl. 340/984

(57) ABSTRACT

The vessel control device disclosed herein comprises a channel-mounted, spring-loaded eyebolt that trails a floating line. It also embodies a latch mechanism, a cable release device and an electrical switch.

By the action of grabbing the line the man overboard victim (MOB) can stop the vessel by himself; then use the line to reboard.

### FIELD OF SEARCH

441/80

### REFERENCES CITED

U.S. Patent Documents:

| | | | |
|---|---|---|---|
| 4,909,171 | Mar. 20, 1990 | Powers | 441/80 |
| 5,006,831 | Apr. 9, 1991 | Solminihac | 441/80 |
| 5,192,238 | Mar. 9, 1993 | Brown | 441/80 |
| 5,748,080 | May 5, 1998 | Clay | 441/80 |
| 5,779,511 | Jul. 14, 1999 | Davidson | 441/80 |
| 6,093,070 | Jul. 25, 2000 | Mannes | 441/80 |
| 7,238,074 | Jul. 3, 2007 | Berndt | 441/80 |

### BACKGROUND OF THE INVENTION

1. Field of the Invention

This invention is a device which will enable a man overboard victim to rescue himself. A tug on the trailing floating line will stop the vessel. The line is then used to aid him in reboarding his vessel.

2. State of Prior Art

U.S. Pat. No. 4,909,171 requires a sailor to be continuously attached to a line terminating at the bow. While it is a common safety practice to wear a tethered harness attached to the boat, a long line to the bow would seriously impede his normal activities. This could result in pulling the pin with a trip or fall. While the device will not stop the boat, the claim is to keep it near the victim. There is no provision for reboarding the vessel.

U.S. Pat. No. 5,006,831 requires a man to wear an acoustic signal generator. Additional crew are required to locate and rescue him.

U.S. Pat. No. 5,192,238 describes a device activated by a trailing line that by use of a sea anchor, harness, line and pulley will bring the victim back to a moving vessel. This device will not stop a moving vessel, and it would be very difficult to attach the harness while it is being pulled through the water. This method is bulky and expensive and could injure the victim by smashing him into the transom.

U.S. Pat. No. 5,748,080 describes a light and radio signaling device to be used by a person in the water. This won't stop the vessel and requires additional crew.

U.S. Pat. No. 5,779,511 describes a sheet-like lifting harness for bringing a victim back aboard. This requires additional crew.

U.S. Pat. No. 6,093,070 describes a large lifting crane for victim retrieval. This also requires additional crew.

U.S. Pat. No. 7,238,074 describes a method of retrieving an object in the water. This also requires additional crew.

None of the above mentioned devices will both stop a vessel and provide a means to reboard it. Most require additional crew

### OBJECTIVES

It is an object of this invention to allow a Man Overboard Victim (MOB) to shut down his engine.

It is also an object of this invention to allow the MOB to move the rudder fully to one side.

It is also an object of this invention to stop the boat dead in the water.

It is also an object of this invention to sound an alarm to alert any additional crew members who are on board.

It is also an object of this invention to provide the MOB with a floating line attached to the vessel.

It is also an object of this invention that the attached floating line will provide a means for the MOB to reboard the vessel.

These and other objectives as described hereinafter are capable of being met by the device of this invention.

### STATEMENT OF THE INVENTION

In accordance with the present invention it has been found that the above objectives are fully met by operation of the device of this invention.

This device is comprised of a spring-loaded eye bolt, an electrical switch and a cable release pin (part of the eye bolt). All are housed inside a structural aluminum channel section which mounts on the stern of the vessel. In addition, a floating line is attached to the eye bolt.

When the MOB grabs the moving line with a jerk pull of approximately 75 pounds the eye bolt will compress the spring against the channel, withdraw from its retaining hole and latch. The latch is accomplished due to the misalignment of the compressed eye bolt which is unable to re-enter its retaining hole. The misalignment has two causes: the first being the inside taper of the channel section, item 1. The second is caused by the upward force of the contact spring, item 6. When the device is latched any attached cable is released and the electrical switch is closed.

The device of this invention may be further described by reference to the drawings in which:

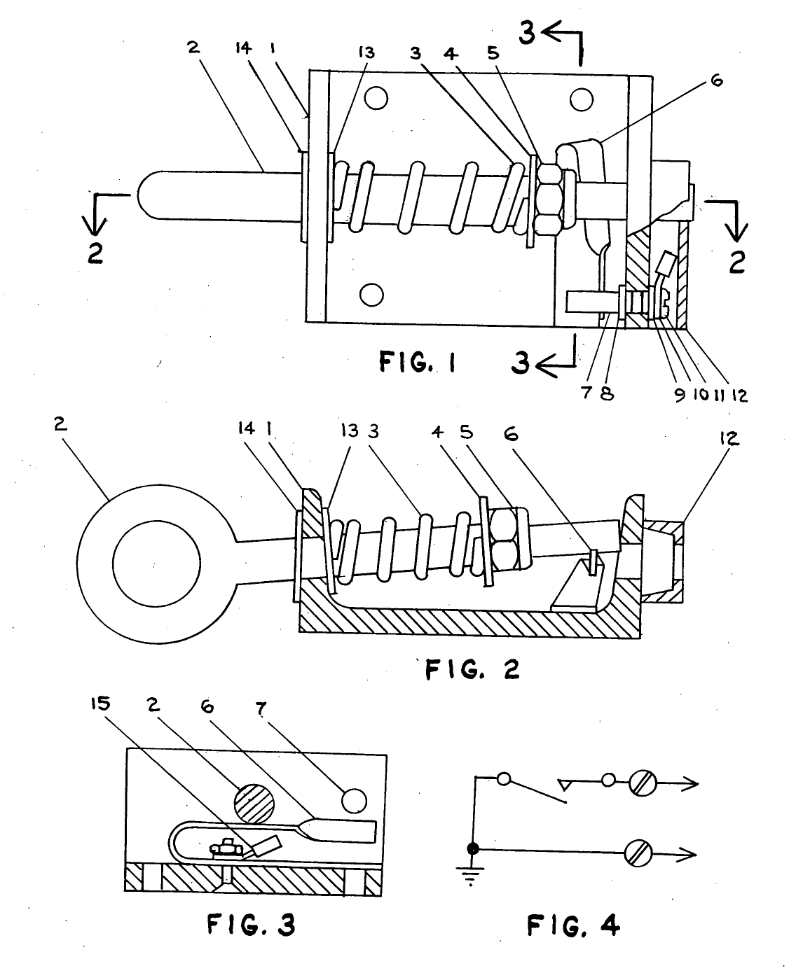

FIG. 1 is a plan view of the device showing virtually all parts in the relaxed, non-compressed position. The eye bolt, item 2, which is also the cable retention pin, is shown protruding completely through the cable retention channel, item 12. The contact spring, item 6, is held depressed by 2 and away from the contact pin, item 7. Item 7 is isolated from the channel section, item 1, by insulating shoulder washers, items 8 and 9. A retaining screw, item 11, connects the crimp terminal, item 10, to 7 and binds them together. Flat washers, items 13 and 14, and the lock nut, item 5, provide tension adjustment for the compression spring, item 3.

FIG. 2 is a section view taken at line 2-2 of FIG. 1. This view best describes the structural channel section, item 1, to which all other parts are mounted. In this view 3 is fully compressed between 13 and 1 at one end, and 5 and flat washer, item 4, at the other end. The eye bolt, item 2, under maximum pressure, having been pulled out of 12 and out through the retaining hole of 1 is stuck against the top of that hole and is now “latched”. The contact spring 6 is shown in the relaxed, “closed contact” position, no longer depressed open by 2.

The eye bolt/cable retention pin 2 is shown pulled out of 12, thus releasing the cable end. With the exception of the two channel sections and the nickel-plated brass contact pin 7, all other metallic parts are stainless steel.

FIG. 3 is a section view taken at line 3-3 of FIG. 1. This shows the contact spring 6 being held away from 7 by 2. This also displays the attachment of the ground crimp terminal, item 15.

FIG. 4 is an electrical schematic representation of the switch in FIG. 3.

While certain features of this invention have been described in detail with respect to various embodiments thereof, it will of course be apparent that other modifications can be made within the spirit and scope of this invention, and it is not intended to limit the invention to the exact details insofar as they are defined in the following claims

The invention claimed is:

1. A towed line, pull-activated device embodying a unique off-center latching system, a cable release mechanism and an electrical switch.

2. The device of claim 1, when caused to latch by a person grabbing the attached trailing line, will cause the following events as applicable:
(a) The released cable, by means of springs, surgical tubing or elastic cord, will:
1. cause the wind-steering assembly to move the rudder fully to one side thus stopping the forward motion of the vessel;
2. cause a cable-linked fuel block unit to shut down a diesel engine.
(b) The electrical switch closure will:
1. cause the fuel block solenoid to shut down a diesel engine;
2. disable the ignition system of a gasoline engine;
3. cause the autopilot to move the rudder fully to one side thus stopping the forward motion of the vessel;
4. activate an audible alarm to alert additional crew, if any.
(c) After the vessel stops dead in the water the victim can reboard in one of the following ways:
1. He can climb up the transom swim steps if any;
2. He can pull down a hinged ladder;
3. He can climb up the wind-steering assembly;
4. He can flip the line over the boom and hoist himself aboard;
5. He can loop the line over a stern pulpit rail and form a step to hoist himself up;
6. He can form a loop in the line and secure it with an overhand knot thus creating a step or steps to climb back aboard.

3. I further claim that this line-activated switch and cable release device is not limited to use on a vessel.
